(19) United States
(12) Patent Application Publication
(10) Pub. No.: US 2026/0022996 A1
(43) Pub. Date: Jan. 22, 2026

(54) SLIDE CADDY FOR TISSUE PREPARATION

(71) Applicant: Ian M Aikens, Mims, FL (US)

(72) Inventor: Ian M Aikens, Mims, FL (US)

(21) Appl. No.: 19/246,351

(22) Filed: Jun. 23, 2025

Related U.S. Application Data
(60) Provisional application No. 63/672,488, filed on Jul. 17, 2024.

(51) Int. Cl. G01N 1/28

(52) U.S. Cl. CPC G01N 1/286

(57) ABSTRACT

A device and method for preparing frozen tissue specimens are disclosed. The device includes a solid block having a top surface and a bottom surface, with two parallel side walls extending upward from the top surface. A slotted groove is formed in the middle of the solid block and extends from the top surface to the bottom surface to receive a specimen chuck, such that a head of the chuck rests on the top surface. Top edges of the side walls support a tissue slide containing an encapsulated specimen. The device may include finger grooves for manual handling and is preferably made of a heat-conducting material to assist in rapid freezing. The method involves placing the specimen chuck in the groove, depositing a freezing medium over it, and positioning the tissue slide so that the specimen contacts the freezing medium for effective specimen preparation.

### CROSS REFERENCE TO RELATED APPLICATIONS

This application claims priority from a U.S. Provisional Patent Application No. 63/672,488, filed on Jul. 17, 2024, which is incorporated herein by reference in its entirety.

### FIELD OF INVENTION

The present invention relates to a slide caddy for tissue preparation, and more specifically, the present invention relates to a slide caddy for use in frozen tissue sectioning or Mohs surgery slide preparation.

### BACKGROUND

Tissue preparation is a critical process in diagnostic medicine and scientific research. Techniques for preparing thin slices of tissue—commonly referred to as histological or histopathological techniques—enable microscopic examination of tissue morphology. Such analysis is essential for diagnosing a wide range of diseases, including various forms of cancer, and is also fundamental to studies aimed at understanding tissue structure and pathological changes over time.

One widely used method of tissue preparation is frozen sectioning, which offers significant advantages in both clinical and research contexts. These include rapid diagnostic turnaround and enhanced preservation of biological features. Frozen sectioning is typically carried out using a device known as a cryostat, which is a precision instrument designed to cut thin slices of frozen tissue for mounting on microscope slides. A typical cryostat includes a chuck for holding a tissue specimen, along with a microtome or blade assembly for slicing the tissue.

Prior to sectioning, the tissue sample is embedded in an Optimal Cutting Temperature (OCT) compound and frozen to achieve the necessary firmness for slicing. Several tools exist for the embedding process. For instance, Pathology Innovations offers “Embedding Well Bars,” which are stainless steel bars with wells machined into their surface. These bars are stored inside the cryostat and act as heat sinks to facilitate freezing of the OCT-embedded tissue blocks. Pathology Innovations also provides proprietary chucks that are compatible with select instruments, although they often require precise leveling to ensure a flat surface. Another example, disclosed in U.S. Pat. No. 7,059,139 (U.S. Pat. No. 7,059,139B1), describes a method and apparatus for preparing tissue specimens using connectable sections with hollowed cylinders to receive button-like components. These buttons feature planar disc portions to support tissue specimens and cylindrical stems for insertion into the apparatus.

Despite the availability of these cryo-embedding tools, they suffer from several limitations. Notably, many are only compatible with a narrow range of chuck designs, restricting their use across different cryostat models. Additionally, the embedding process itself can be cumbersome and unintuitive, reducing efficiency in time-sensitive diagnostic settings. Therefore, there is a recognized need for an improved device that simplifies the preparation of tissue specimens for frozen sectioning while ensuring broad compatibility with existing cryostat systems.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a slide caddy, also referred to herein as a device, for frozen tissue preparation.

Another object of the present invention is that the slide caddy can be used with the most standard chucks, making it versatile.

Still another object of the present invention is that the slide caddy can be used with slides.

Yet another object of the present invention is that the slide caddy may make the process easier and quicker.

A further object of the present invention is that the slide caddy can secure the chuck of varying sizes.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a top and side perspective view of a slide caddy, according to an exemplary embodiment of the present invention.

FIG. 2 shows a bottom and side perspective view of the slide caddy, according to an exemplary embodiment of the present invention.

FIG. 3 shows a top view of the slide caddy, according to an exemplary embodiment of the present invention.

FIG. 4 shows the slide caddy in use condition, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The present invention relates to a device designed for use during frozen sectioning procedures, including Mohs micrographic surgery slide preparation. The device facilitates the processing of tissue specimens within a cryostat, specifically for embedding tissue in a freezing medium and transferring the embedded specimen onto a specimen chuck for sectioning. A key advantage of the disclosed device is its compatibility with standard chucks provided with most cryostats, eliminating the need for specialized or proprietary components.

The device is designed to accommodate a wide range of chuck sizes, including but not limited to 20 mm, 25 mm, 30 mm, 35 mm, 40 mm, and 45 mm in diameter. This versatility enables broader usability across different cryostat systems. In addition, the device supports the use of standard microscope slides for tissue preparation. For example, the commonly used slide dimensions of approximately 50 mm×25 mm can be utilized seamlessly with the device. It should be noted, however, that the device may be adapted to work with various slide types and sizes used in histopathology. These slides are typically fabricated from transparent glass to allow microscopic examination.

The disclosed device enables stable and precise positioning of the tissue slide relative to the specimen chuck during the tissue preparation process. It ensures that the specimen chuck remains flat and steady throughout the embedding procedure. Likewise, the tissue slide is maintained in a flat and properly aligned orientation with respect to the chuck, regardless of the user's level of handling expertise. This consistent alignment facilitates efficient and repeatable transfer of the embedded tissue from the slide to the chuck.

By maintaining a controlled and reproducible spatial relationship between the slide and the chuck, the device effectively minimizes human-induced variability in tissue preparation. As a result, it ensures uniformity and accuracy in the placement of tissue specimens on the chuck, thereby improving the quality and reliability of frozen sectioning outcomes.

The disclosed device is compatible with widely used slide-based tissue embedding methods and is designed to streamline and accelerate the process. It ensures that the tissue specimen remains level during embedding, thereby reducing or eliminating the need for manual adjustments during the orientation step. Notably, the device compensates for minor imperfections in the leveling of the cryostat or work surfaces, eliminating the necessity for precise instrument leveling.

The device securely holds both the tissue slide and the cryostat specimen chuck in a stable and fixed orientation relative to each other. This stability contributes to consistent, high-quality tissue transfers and minimizes the potential for user-induced misalignment or error during preparation.

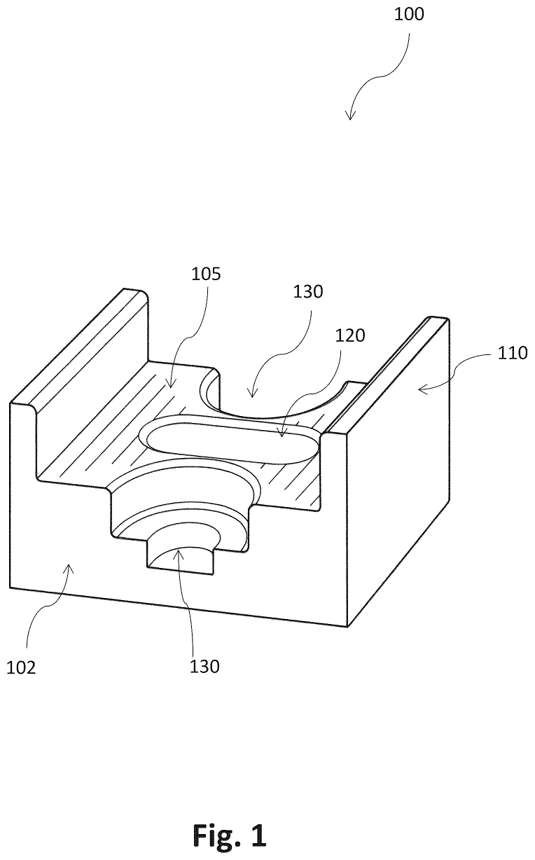

Referring to FIGS. 1-3, an exemplary embodiment of the disclosed device 100 for frozen tissue processing and Mohs surgery is illustrated. The device 100 includes a platform 105 and is generally formed as a solid block 102 having a top surface, bottom surface, left and right side surfaces, and front and rear surfaces.

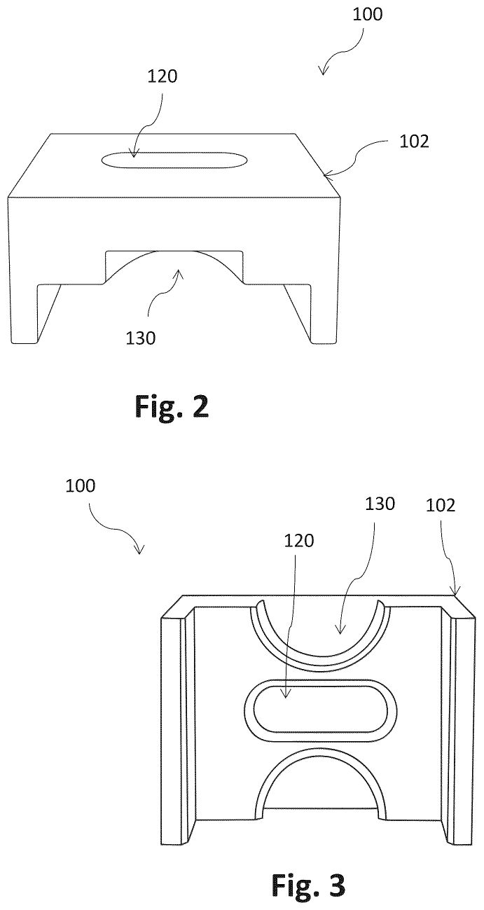

FIG. 1 presents a top and side perspective view of the device, FIG. 2 shows a bottom and side perspective view, and FIG. 3 provides a top view.

The bottom surface of the block 102 is planar, allowing the device to rest stably on a flat surface, such as a laboratory bench or table. The top surface of the block extends between two opposing, parallel side walls 110 and defines the platform 105. These side walls 110 are oriented perpendicular to the top surface and extend vertically upward from it. Both side walls are of equal height, measured from the base to the top edge.

The top edges of the side walls 110 serve as a support base on which a microscope slide can be positioned. The spacing between the two opposing side walls is slightly less than the length of a standard slide, thereby enabling secure placement and alignment of the slide across the top of the device.

As shown in the drawings, the solid block 102 may have an elongated rectangular profile. However, it should be noted that the shape and size of the solid block can be modified without departing from the scope of the present invention. In the illustrated embodiment, the length of the solid block extends between the two opposing side walls.

The solid block 102 may include a slotted groove 120 that extends from the top surface to the bottom surface of the block. As illustrated in FIGS. 1 and 2, the slotted groove 120 may be configured as a passthrough, allowing full vertical access. The groove is of an elongated profile, with its length extending substantially along the longitudinal axis of the rectangular solid block.

It should be noted that the shape, dimensions, and orientation of the slotted groove may be modified without departing from the scope of the present invention. The groove is designed to receive the stem of a specimen chuck, while allowing the head of the chuck to rest on or above the top surface of the block. The position of the chuck within the slotted groove can be adjusted to align precisely with the tissue specimen on the slide, providing flexibility and control during tissue transfer.

Positioned adjacent to the slotted groove 120 and extending laterally on either side of the solid block 102 are two finger grooves 130—one on the left and one on the right. These finger grooves 130 are cutouts or recesses formed in the body of the solid block, designed to facilitate easy access to and removal of the specimen chuck from the slotted groove.

It should also be noted that the height of the sidewalls extending above the top surface of the block is a critical design feature. This height plays a key role in maintaining the proper alignment and positioning of the slide and tissue specimen during preparation, contributing to the precision and repeatability of the tissue embedding process.

The device may be constructed from any suitable material that exhibits good thermal conductivity, which is essential for effective heat transfer during the tissue freezing process. Suitable materials include, but are not limited to, stainless steel and aluminum. Preferably, the material should also be corrosion-resistant to minimize the risk of contamination and ensure long-term durability in clinical or laboratory environments. Additionally, the surfaces of the device are preferably smooth and non-porous, which helps prevent the accumulation of contaminants and facilitates easy cleaning and sterilization between uses.

Also disclosed is a method for using the device 100 to prepare frozen tissue specimens. The device facilitates the placement, orientation, and freezing of the tissue in a controlled, level plane relative to a microscope slide, commonly a transparent glass slide. In this method, the tissue specimen is first placed on the flat surface of the glass slide using the standard glass slide technique. The transparency of the slide allows the user to visually verify that all surgical margins of the tissue are properly positioned and flattened against the slide surface.

Once positioned, the tissue is encapsulated in a suitable embedding medium, such as an optimal cutting temperature (OCT) compound, to form a “tissue button.” Meanwhile, the specimen chuck is prepared by applying a freezing medium to its top surface, referred to herein as the “disc button.” The chuck can either be placed in the slotted groove 120 of the device prior to or after the application of the freezing medium. In either case, the medium is deposited up to a desired height to allow proper fusion with the tissue button.

The slide with the encapsulated tissue is then positioned over the mounted chuck, such that it rests on the top edges of the two opposing sidewalls 110 of the device. While the freezing medium and encapsulating medium are still semi-solid, the positioning of the slide ensures that both media come into contact and fuse together. The entire setup can then be frozen either by placing the device onto a freezing surface or by applying a freezing agent (e.g., a cryospray) directly to the device.

This freezing process results in the formation of a unified tissue block-commonly referred to as a Mohs block-that is ready for sectioning. Once frozen, the slide can be removed from the tissue block using appropriate methods, such as over-freezing or briefly warming the slide surface. The resulting specimen disc mounted on the chuck is now ready for further histological processing and sectioning.

Following encapsulation of the tissue with a suitable embedding medium, the freezing process may be initiated. Freezing can be accelerated by applying a freeze spray directly onto the slide. Once the tissue is adequately frozen and bonded to the slide, the slide is inverted to transfer the tissue onto the specimen disc of the chuck. Separation of the slide from the frozen medium may be achieved by either over-freezing or by briefly applying heat, such as from the palm of the hand.

The disclosed device facilitates a level and stable interface between the slide and the specimen disc during this process, ensuring that the tissue transfer occurs on a flat, consistent plane. Achieving such flatness is critical for producing accurate and uniform tissue sections. By maintaining proper alignment and orientation, the device enables quick, reliable, and level mounting of the frozen tissue from the slide to the specimen disc, thereby enhancing the precision and reproducibility of tissue sectioning.

In use, one or more relief cuts may be made in the tissue specimen to allow it to lay flat, and orientation markers may be applied using tissue dye. The tissue is then deposited onto a microscope slide, with gentle downward pressure applied to the edges and center of the tissue to ensure it lies in a flat, uniform plane.

Next, the tissue is encapsulated with a suitable freezing medium, such as an OCT compound. The underside of the slide is then sprayed with a freezing agent until the embedding medium solidifies. In parallel, a specimen chuck is prepared by applying a layer of freezing medium to its upper surface. The chuck is then positioned into the slotted groove of the device.

Additional freezing medium may be applied onto the chuck within the groove, aligning it to receive the frozen tissue. The slide containing the encapsulated tissue is then positioned onto the top edges of the device's side walls, such that the tissue surface faces the freezing medium on the chuck. Excess medium may be removed at this stage to ensure clean and level contact.

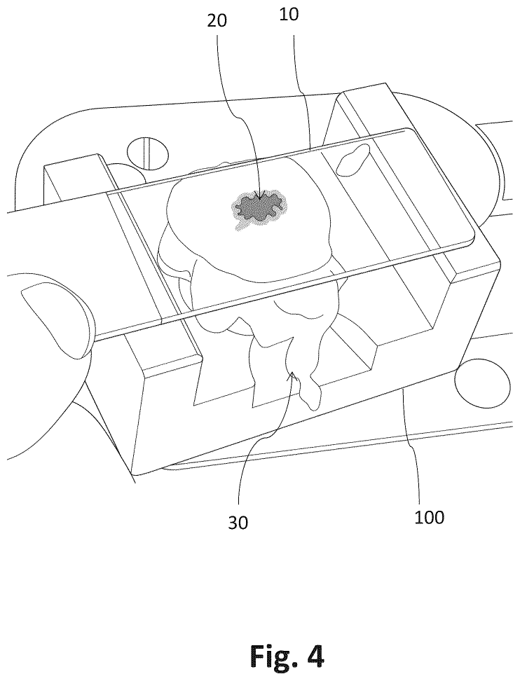

Clamping pressure is applied to the slide and the device, either manually or using a slide caddy or fixture. While maintaining this clamping pressure, freezing spray is applied to complete the bonding and solidification of the tissue onto the specimen chuck. Once the freezing process is complete, the slide and the chuck (with frozen tissue attached) can be removed from the device for further processing. FIG. 4 shows the slide 10, tissue 20, and chuck 30.

The foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A device for preparing a frozen tissue specimen, the device comprises:
a solid block having a top surface and a bottom surface;
two side walls extending upward from the top surface, wherein the top surface extends between the two side walls and is perpendicular to the two side walls, the two side walls being opposite and parallel to each other; and
a slotted groove disposed in a middle portion of the solid block extending from the top surface to the bottom surface.

2. The device of claim 1, wherein the device further comprises two finger grooves disposed on left and right sides of the solid block, wherein the two side walls are positioned on front and rear sides of the solid block respectively.

3. The device of claim 1, wherein a height of the two sidewalls above the top surface is proportional to a thickness of the frozen tissue specimen.

4. The device of claim 3, wherein the slotted groove is configured to receive a specimen chuck, wherein a head of the specimen chuck rests on the top surface, and wherein top edges of the two sidewalls are configured to support a tissue slide.

5. The device of claim 2, wherein the solid block has a rectangular profile, the two side walls are along shorter sides of the rectangular solid block, and the two finger grooves are along longer sides of the rectangular solid block.

6. The device of claim 5, wherein the device is made of a heat conducting material.

7. A method for preparing a frozen tissue specimen, the method comprising:
providing a device comprising:
a solid block having a top surface and a bottom surface;
two side walls extending upwards from the top surface, wherein the top surface extends between the two side walls and is perpendicular to the two side walls, the two side walls being opposite and parallel to each other; and
a slotted groove disposed in a middle portion of the solid block and extending from the top surface to the bottom surface;
placing a specimen chuck in the slotted groove, such that a head of the specimen chuck rests on the top surface of the solid block;
depositing freezing medium over the specimen chuck; and
positioning a slide with encapsulated tissue over top edges of the two side walls such that the encapsulated tissue contacts with the freezing medium over the chuck.

8. The method of claim 7, wherein the device further comprises two finger grooves disposed on left and right sides of the solid block, and wherein the two sidewalls are located on front and rear sides of the solid block, respectively.

9. The method of claim 7, wherein a height of the two side walls above the top surface is proportional to a thickness of the frozen tissue specimen.

10. The method of claim 8, wherein the solid block has a rectangular profile, the two side walls are along shorter sides of the rectangular solid block, and the two finger grooves are along longer sides of the rectangular solid block.

11. The method of claim 7, wherein the device is made of heat-conducting material.
